(19) United States
(12) Patent Application Publication
(10) Pub. No.: US 2023/0418092 A1
(43) Pub. Date: Dec. 28, 2023

(54) THERMO-OPTICAL PHASE SHIFTER

(71) Applicant: Silith Technology (Suzhou) Co., Ltd., Shanghai (CN)

(72) Inventor: Xingyu ZHANG, Shanghai (CN)

(73) Assignee: Silith Technology (Suzhou) Co., Ltd., Shanghai (CN)

(21) Appl. No.: 18/035,838

(22) PCT Filed: Feb. 25, 2022
(86) PCT No.: PCT/CN2022/078001

§ 371 Date: May 8, 2023

(30) Foreign Application Priority Data
Oct. 20, 2021 (CN) 202111220232.4

(51) Int. Cl. G02F 1/01

(52) U.S. Cl. CPC G02F 1/0147

(57) ABSTRACT

The present invention provides a thermo-optical phase shifter including a cladding and n optical waveguide core, wherein the cladding surrounds the optical waveguide core, the optical waveguide core includes a first section and a second section, and dimensions of the first section and the second section are different. The thermo-optical phase shifter can improve that efficiency of the phase shifter and reduce optical crosstalk.

### CROSS-REFERENCE

This application claims the priority of Chinese patent application No. 2021112202324 filed on Oct. 20, 2021. The contents of the above application are incorporated herein by reference.

### FIELD OF TECHNOLOGY

The invention relates to the field of integrated optical components, and in particular to a thermo-optical phase shifter.

### BACKGROUND

A thermo-optical phase shifter is an important part of a photonic integrated circuit. Traditional thermo-optical phase shifters are usually provided with conductive heaters adjacent to or integrated with optical waveguides. When current flows through the heater, the heater generates heat energy, which can change the refractive index of the waveguide through the thermo-optic effect. In this way, the phase of light waves propagating through the light guide is shifted.

Currently, in order to improve the efficiency of the thermo-optical phase shifter, one method is to change the waveguide into a loop shape, so that heat generated by one heater can be shared by multiple waveguides, thus improving the efficiency of the thermo-optical phase shifter. However, in this structure, the waveguide is usually very long, and some parts of the waveguide, such as some looped waveguide, cannot be heated, thus these parts of the waveguide do not contribute to the phase shift while still occupying a large space. In addition, the geometry of the loop waveguide must be carefully optimized to reduce additional optical loss. However, in this type of loop waveguide, the waveguide spacing needs to be made small to improve the efficiency of the thermo-optical phase shifter, however this makes the optical crosstalk worse. On the other hand, if the spacing between the waveguides is too large to suppress crosstalk, it makes devices less compact and the heating efficiency is reduced.

Therefore, it is urgent to provide a thermo-optical phase shifter which can balance the heating efficiency and optical crosstalk.

### SUMMARY

The objective of the present invention is to provide a thermo-optical phase shifter so as to achieve the improvement of the efficiency of the phase shifter and reduction of optical crosstalk.

In a first aspect, the present invention provides a thermo-optical phase shifter comprising a cladding and an optical waveguide core. The cladding is configured to surround the optical waveguide core; the optical waveguide core includes a first section and a second section, and dimensions of the first section and the second section are set to be different.

The thermo-optical phase shifter provided by the present invention has the beneficial effects that: based on the coupled mode theory, the evanescent coupling between sections with different dimensions in the optical waveguide core can't achieve phase matching, so that the optical crosstalk between the sections with different dimensions at a certain spacing can be neglected; compared with the thermo-optical phase shifter using the same dimension, the thermo-optical phase shifter provided by the present invention has a more compact structure, so that the phase shift efficiency is greatly improved. It can be seen that the thermo-optical phase shifter provided by the present invention can improve the efficiency of the phase shifter and reduce the optical crosstalk.

In a possible embodiment, the thermo-optical phase shifter further includes a resistive heater, wherein the resistive heater is surrounded by the cladding and located on one side of the optical waveguide core, and the resistive heater is separated from the optical waveguide core by the cladding; a certain distance is kept between the resistive heater and the optical waveguide core, which can ensure that the optical waveguide core can be fully heated so as to improve the efficiency of the phase shifter; and it should be noted that the distance between the resistive heater and the optical waveguide core should not be too far, otherwise the heating efficiency will be affected. In this way, when the current flows through the heater, heat energy is generated, and the waveguides with different dimensions under the heater have changes in refractive index due to the thermo-optic effect, which finally causes phase shift of light waves propagating through the optical waveguide core.

In a possible embodiment, the optical waveguide core made by some semiconductor materials can have resistance performance by ion doping. In this way, the doped optical waveguide core itself has the heating capability, and when current flows through the optical waveguide core, heat energy is generated, and the waveguides with different dimensions have changes in refractive index due to a thermo-optic effect, which finally causes phase shift of light waves propagating through the optical waveguide core.

In a possible embodiment, the optical waveguide core is in a spiral or loop shape in space. This helps to save the space on the optical integrated circuit components and devices, and the integration density of the optical integrated circuit components and devices is higher.

In a possible embodiment, the optical waveguide core further includes a bridge structure, one end of the bridge structure is connected with the first section, and the other end of the bridge structure is connected with the second section. This bridge structure connects different sections together. Optionally, a bending shape of the bridge structure includes at least one of an arc shape, an Euler bending shape and a sinusoidal shape.

In a possible embodiment, a bending portion of a section of the optical waveguide core also includes at least one of an arc shape, an Euler bending shape and a sinusoidal shape, so as to realize helical distribution or loop distribution in space.

In a possible embodiment, the dimension of the bridge structure gradually changes from small to large or from large to small from one end to the other end.

In a possible embodiment, the bridge structure includes a first bridge structure portion and a second bridge structure portion, wherein the first bridge structure portion is a bend waveguide with a uniform dimension, and the second bridge structure portion is a straight waveguide with the dimension gradually changing from one end to the other end.

In a possible embodiment, an air trench or air undercut for thermal insulation is arranged or formed in the cladding, and the air trench or air undercut is located around the optical waveguide core. Through deep dry etching and wet etching processes, an air trench or air undercut, such as an air-filled closed cavity or an air opening, can be formed around the thermo-optical phase shifter described above. This air trench or air undercut reduces the heat conduction path, so that the heat energy can be locally captured to improve the heating efficiency.

In a possible embodiment, a material of the resistive heater includes, but is not limited to, at least one of titanium nitride, doped silicon, tungsten, gold and other materials.

In a possible embodiment, the resistive material includes, but is not limited to, at least one of titanium nitride, doped silicon, tungsten and gold.

In a possible embodiment, the material of the optical waveguide core includes, but is not limited to, at least one of silicon, silicon nitride, silicon dioxide, aluminum oxide, lithium niobate, polymer, germanium or III-V and other materials.

In a possible embodiment, a waveguide type of the optical waveguide core includes, but is not limited to, at least one of a channel waveguide, a ridge waveguide, a slot waveguide, a diffused waveguide and other types.

In a possible embodiment, a wavelength of the optical waveguide core includes, but is not limited to, at least one of a visible light range, a O-band range, a C-band range, a mid-infrared range and other ranges.

Other features will be described in the detailed description.

### BRIEF DESCRIPTION OF THE DRAWINGS

FIG. 1 is a top view and a sectional view of a thermo-optical phase shifter provided by the present invention without showing an external resistive heater;

FIG. 2 shows two bridge structures of different structures provided by the present invention;

FIG. 3A is a top view of another thermo-optical phase shifter provided by the present invention without showing the external resistive heater;

FIG. 3B is a sectional view along line L in FIG. 3A provided by the present invention;

FIG. 4 is a top view and a sectional view of another thermo-optical phase shifter provided by the present invention without showing the external resistive heater;

FIG. 5 is a top view of a thermo-optical phase shifter with air trench and air undercut based on FIG. 4 provided by the present invention;

FIG. 5A is a perspective view of another thermo-optical phase shifter with the resistive heater provided by the present invention;

FIG. 5B is a top view of the thermo-optical phase shifter in FIG. 5A provided by the present invention;

FIG. 5C is a sectional view along line L in FIG. 5B provided by the present invention;

FIG. 5D is a schematic diagram of the thermo-optical phase shifter in FIG. 5A provided by the present invention with an air trench and air undercut; and

FIG. 6 shows simulation results of the working efficiency of three thermo-optical phase shifters on a silicon photonics platform.

### REFERENCE NUMERALS IN THE FIGURES

10. thermo-optical phase shifter; 101. cladding; 102. optical waveguide core; 103. resistive heater.

### DESCRIPTION OF THE EMBODIMENTS

In order to make the objectives, technical solutions and advantages of the present invention clearer, the technical solutions in the embodiments of the present invention will be described clearly and completely below in conjunction with accompanying drawings. Apparently, the embodiments described are some of embodiments of the present invention, but not all of the embodiments. All of the other embodiments, obtained by those of ordinary skill in the art based on the embodiments of the present invention without any inventive efforts, fall into the protection scope of the present invention. Unless defined otherwise, technical or scientific terms used herein have the same meaning as commonly understood by one of ordinary skill in the art to which this invention belongs. As used herein, “comprising”, “including” and the similar words mean that elements or articles appearing before the word encompass the elements or articles or equivalents thereof listed after the word, but do not exclude other elements of articles.

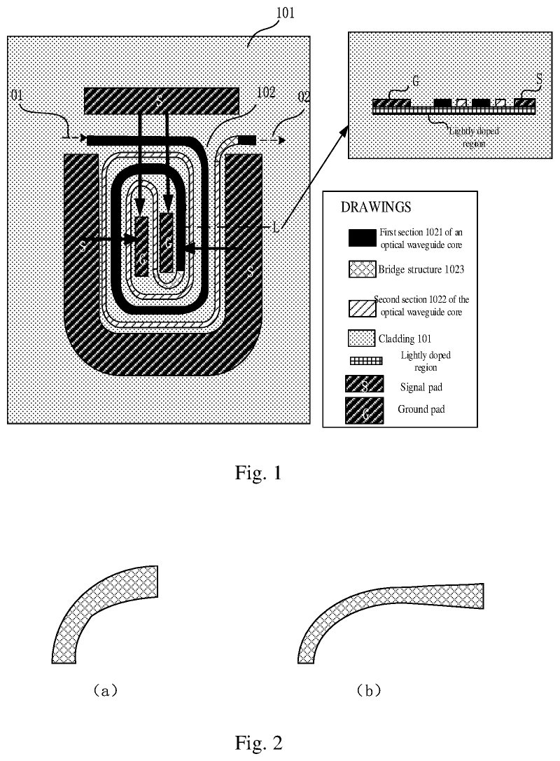

Aiming at the problems existing in the prior art, an embodiment 1 of the present invention provides a thermo-optical phase shifter 10, as shown in FIG. 1, including a cladding 101 and an optical waveguide core 102 which has resistance performance by ion doping in advance.

Where, the optical waveguide core 102 includes a first section or segment 1021 and a second section or segment 1022, and dimensions of the first section 1021 and the second section 1022 are set to be different. In FIG. 1, the dimension of the first section 1021 is larger than that of the second section 1022. It should be noted that the dimension of the first section 1021 can also be smaller than that of the second section 1022. FIG. 1 is intended to be illustrative only and not limiting.

In another possible embodiment, the optical waveguide core 102 itself is equipped with conductive performance by ion doping. In this way, the doped optical waveguide core 102 itself has a heating function, and when current flows through the optical waveguide core, heat energy is generated, and waveguides with different dimensions have changes in refractive index due to a thermo-optic effect, which finally causes phase shift of light waves propagating through the optical waveguide core. Exemplarily, FIG. 1 shows that the optical waveguide core can be composed of a lightly doped silicon ridge waveguide.

In addition, FIG. 1 also illustrates a sectional view corresponding to line L, from which it can be seen that the dimensions of adjacent optical waveguide cores in cross-section are different. Based on the coupled mode theory, evanescent coupling between different waveguides can't achieve phase matching, so that optical crosstalk of the optical waveguide core to the sections with different dimensions at a certain spacing can be neglected; and compared with the optical waveguide core with the same dimension, the thermo-optical phase shifter has a more compact structure, so that the phase shift efficiency is greatly improved, and the optical crosstalk can also be reduced at the same time.

In FIG. 1, partial regions of a signal (S) pad and a ground (G) pad are heavily doped for ohmic contact. Voltage can pass through the signal (S) and ground (G) regions, resulting in a current passing through the waveguide. Solid arrows between the signal (S) pad and the ground (G) pad in FIG. 1 indicate the flow direction of the current, a dotted arrow 01 in FIG. 1 indicates the input direction of light and a dotted arrow 02 indicates the output direction of light.

In a possible embodiment, in addition to the spiral distribution of the optical waveguide core illustrated in FIG. 1, the optical waveguide core can also be distributed in loops in space. Hereinafter, the spirally distributed optical waveguide core is taken as an example to illustrate, and a structural design described below is also applicable to the thermo-optical phase shifter with the optical waveguide core distributed in loops.

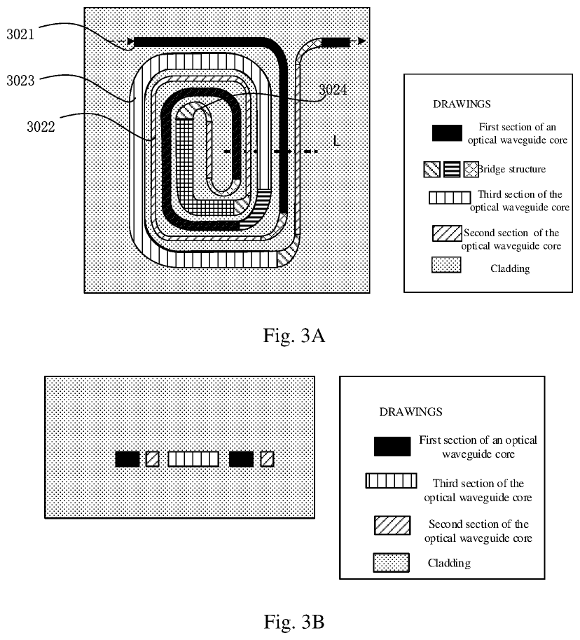

In other possible embodiments, in order to realize transitional connection between the first section 1021 and the second section 1022 of the optical waveguide core, the thermo-optical phase shifter 10 further includes a bridge structure 1023 in a bending shape. One end of the bridge structure 1023 is connected with the first section 1021, and the other end of the bridge structure 1023 is connected with the second section 1022. Because the dimensions of the first section 1021 and the first section 1022 are different, the dimension of the bridge structure 1023 gradually increases from one end to the other end, as shown in FIG. 2(a). Optionally, the bending shape of the bridge structure 1023 may include at least one of an arc shape, a line bending shape, an Euler bending shape, a sinusoidal shape and other types. In addition, optionally, the bridge structure 1023 includes a first bridge structure portion and a second bridge structure portion, wherein the first bridge structure portion is a bend waveguide with a uniform dimension, and the second bridge structure portion is a linear waveguide with the dimension gradually changing from small to large or from large to small from one end to the other end. Exemplarily, as shown in FIG. 2(b), the bridge structure 1023 in the bending may include a regular bending (with a constant dimension) shape and a linear cone shape.

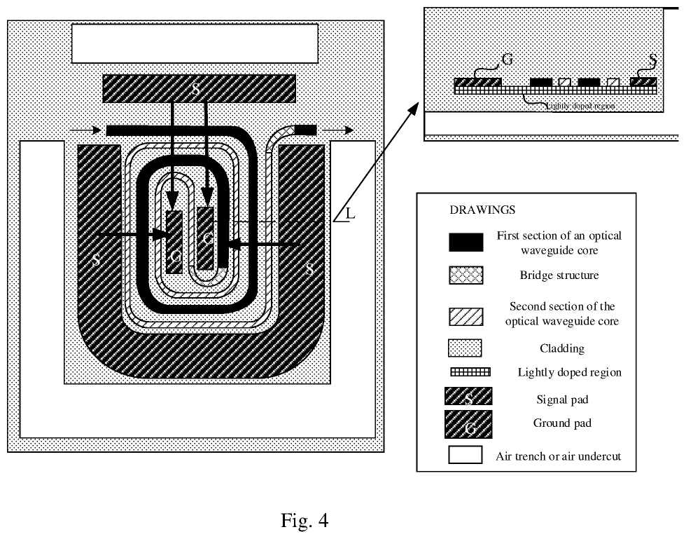

Although the optical waveguide cores with two different dimensions are illustrated in FIG. 1, it is not limited to the optical waveguide cores merely including two different dimensions. In a possible embodiment, the optical waveguide core 102 may include more than two waveguides with different dimensions, that is, it may also include a plurality of third sections and a plurality of bridge structures wherein a number of the third sections is N and a number of the bridge structures is M, the dimensions of the third sections may be all or partially different, so that the dimensions of two spatially adjacent sections of the thermo-optical phase shifter are different. Exemplarily, the optical waveguide core 102 in the thermo-optical phase shifter as shown in FIG. 3A includes a first section 3021, a second section 3022 and a third section 3023, and a bridge structure 3024. It should be noted that the thermo-optical phase shifter in FIG. 3A also includes a signal (S) pad and a ground (G) pad (not shown in the figure). Where, the dimensions of the first section 3021, the second section 3022 and the third section 3023 are different. Exemplarily, in FIG. 3A, the dimension of the first section 3021 is larger than that of the second section 3022, and the dimension of the third section 3023 is larger than that of the first section 3021. In addition, the bridge structures 3024 have different bending shapes to achieve bending. A schematic sectional view corresponding to the dotted line L in FIG. 3A is shown in FIG. 3B. It can be seen from FIG. 3B that the dimensions of the adjacent optical waveguide cores in cross section are different. Based on the coupled mode theory, the evanescent coupling between sections with different dimensions by the optical waveguide core can't achieve phase matching, so that the optical crosstalk between the optical waveguide cores with different dimensions at a certain spacing can be neglected; and compared with the optical waveguide cores with the same dimension, the thermo-optical phase shifter has a more compact structure, so that the phase shift efficiency is greatly improved, and the optical crosstalk can also be reduced at the same time.

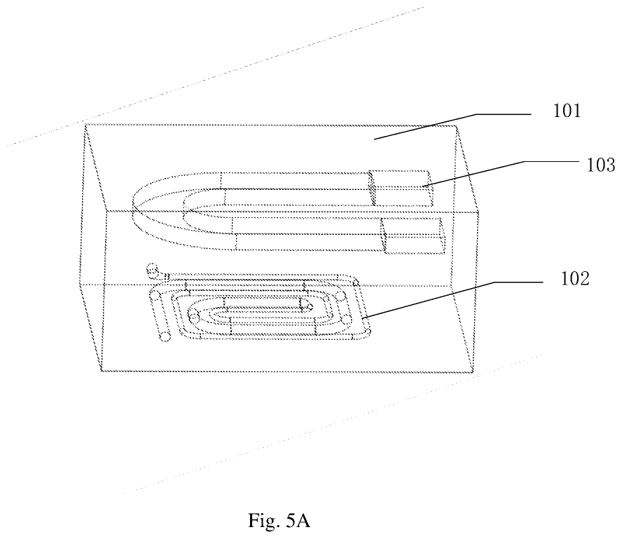

In another possible embodiment, an air trench for thermal insulation is arranged in the cladding 101, and the air trench is located around the optical waveguide core, for the purpose of further improving the phase shift efficiency. As shown in FIG. 4, a thermo-optical phase shifter 10 with an air trench or air undercut, and a corresponding sectional view of the thermo-optical phase shifter 10 along the line L are illustrated, vertical trenches are made near different waveguides and substrates are cut under different waveguides, and through deep dry etching and wet etching processes, air openings can be formed around the thermo-optical phase shifter described above. This isolation reduces the heat conduction path, so that the heat energy can be locally captured to improve the heating efficiency.

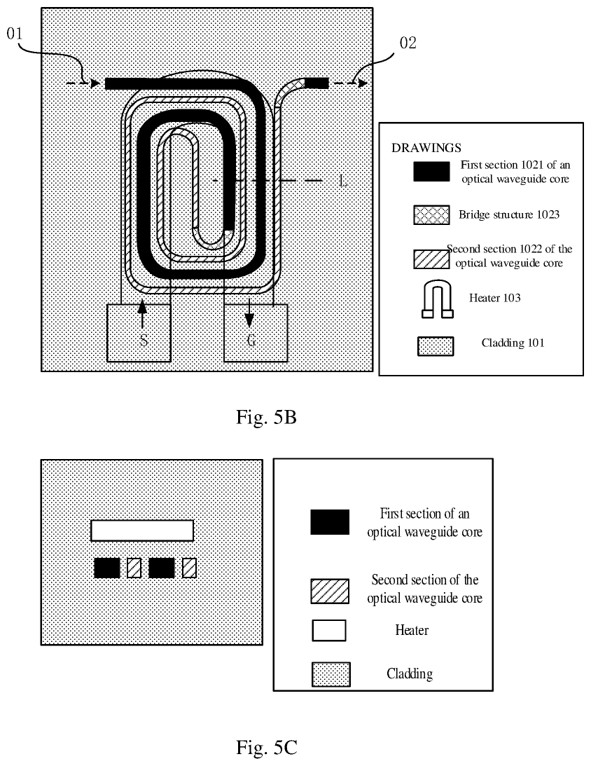

Aiming at the problems existing in the prior art, an embodiment of the present invention further provides a thermo-optical phase shifter 10, as shown in FIGS. 5A to 5C, which includes a cladding 101, an optical waveguide core 102 and a resistive heater 103.

That is to way, the optical waveguide core 102 may not be doped with ions in advance, that is, the thermo-optical phase shifter 10 is a common thermo-optical phase shifter and has no electrical properties, but the thermo-optical phase shifter 10 includes the resistive heater 103, and the resistive heater 103 is surrounded by the cladding 101 and located at one side of the optical waveguide core 102, and keeps a certain distance from the optical waveguide core 102 through the cladding 101, so that fully heating the optical waveguide core 102 is realized. Optionally, the resistive heater 103 can be located on an upper layer of the optical waveguide core 102, or on a side of the optical waveguide core 102, or on a lower layer of the optical waveguide core 102, and a material of the resistive heater includes, but is not limited to, at least one of titanium nitride, doped silicon, tungsten, gold or other types.

Exemplarily, FIG. 5A illustrates a three-dimensional structure of the thermo-optical phase shifter 10 including the resistive heater 103 and the optical waveguide core 102, FIG. 5B illustrates a top view of FIG. 4A, and FIG. 5C is a sectional view along line L of FIG. 5B. It can be seen from the sectional view that the dimensions of the adjacent optical waveguide cores in cross section are different.

As can be seen from structures shown in FIGS. 5A and 5B, one resistive heater 103 is placed on the top of the spiral optical waveguide core. When voltage is applied across the resistive heater 103, for example, through the signal (S) pad and the ground (G) pad, current is generated. Solid arrows between the signal (S) pad and the ground (G) pad in FIG. 5B indicate the flow direction of current, a dotted arrow 01 in FIG. 5B indicates the input direction of light and a dotted arrow 02 indicates the output direction of light. The current passing through the resistive heater 103 generates heat, so that different sections of the optical waveguide core under the resistive heater 103 have changes in refractive index due to the thermo-optic effect, which finally causes the phase shift of the light waves propagating. The dimensions of different sections are different, based on the coupled mode theory, the evanescent coupling between different waveguides can't achieve phase matching, so that the optical crosstalk between optical waveguide cores with different dimensions at a certain spacing can be neglected; compared with the optical waveguide cores with the same dimension, the optical crosstalk at a smaller distance can be neglected; and compared with the waveguides with the same width, the thermo-optical phase shifter has a more compact structure, so that the phase shift efficiency is greatly improved.

In another possible embodiment, in a thermo-optical phase shifter with a resistive heater, an air trench or air undercut for thermal insulation can also be arranged or formed in the cladding 101. Exemplarily, as shown in FIG. 5D, a thermo-optical phase shifter 10 with the air trench or air undercut is illustrated, vertical trenches are made near different waveguides and substrates are cut under different waveguides, and through deep dry etching and wet etching processes, air openings can be formed around the thermo-optical phase shifter described above. This isolation reduces the heat conduction path, so that the heat energy can be locally captured to improve the heating efficiency.

It is worth noting that the number of rounds of the optical waveguide core in a spiral cycle in space can be adjusted according to the requirements. The number of rounds shown in the figure is just an example, and more rounds or fewer rounds can be used to make the total waveguide length larger or smaller. In this embodiment, the curvature radius of the section and the bridge structure needs to be selected according to the actual requirements to minimize the optical loss caused by bending. In addition, the bending shape can be appropriately selected, including but not limited to at least one of a circular arc shape, a spline curve shape, an Euler bending shape, a sinusoidal shape and other types. In order to further reduce the loss, multimode waveguide can be used in different sections of the waveguide. A material of the optical waveguide core includes, but is not limited to, at least one of silicon, silicon nitride, silicon dioxide, aluminum oxide, lithium niobate, polymer, germanium, III-V and other types. A waveguide type of the optical waveguide core includes, but is not limited to, at least one of a channel waveguide, a ridge waveguide, a slot waveguide, a diffused waveguide and other types. A wavelength of the optical waveguide core includes, but is not limited to, at least one of a visible light range, a O-band, a C-band, a mid-infrared range and other ranges.

It is worth noting that the application fields of the thermo-optical phase shifter described above include, but are not limited to, optical sensing, optical computing, optical communication, optical storage, optical radar or other scenes, and the present invention is not limited thereto.

In order to verify the negligible crosstalk in different optical waveguide cores, simulation is performed on a group of five silicon waveguides with different dimensions. For example, in this simulation, five optical waveguide cores with different dimensions are placed horizontally and in parallel, and the dimensions of adjacent sections might be different, such as 0.5 um and 0.8 um, respectively, and the center-to-center spacing of adjacent waveguides is as small as 2 um. Light is emitted to one end of the optical waveguide core, and then the light passes through the waveguide to the right without passing through other waveguides. Therefore, the optical crosstalk between adjacent waveguides can be neglected. Although this simulation is performed on waveguides with different straight lines here, the same concept can also be applied to the thermo-optical phase shifter shown in this embodiment. Through comparison on experimental results, if five waveguides have the same width, light will pass through other waveguides, and there is a serious crosstalk problem, while the thermo-optical phase shifter in this embodiment has little optical crosstalk.

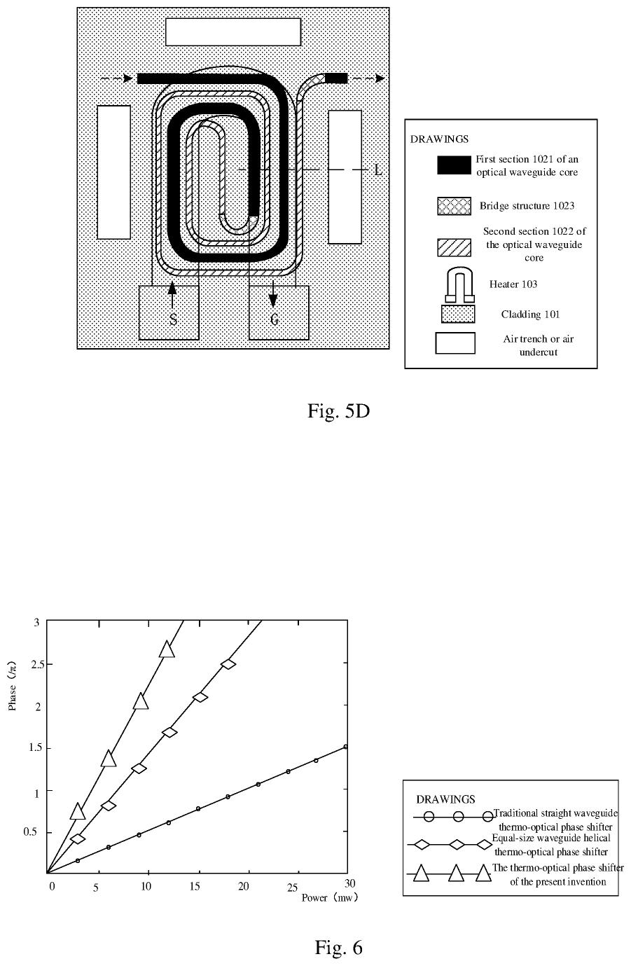

To verify the improved efficiency of the phase shifter, FIG. 6 shows the simulation results of operating efficiency of three thermo-optical phase shifters on a silicon photonics platform as an example. The three curves represent three phase shifter structures, namely, a traditional straight waveguide phase shifter, a spiral equal-size waveguide phase shifter and the phase shifter provided by this embodiment (the present invention). It can be seen that in order to achieve a certain phase shift, the power consumption of the spiral unequal-size waveguide phase shifter is the minimum.

Although the embodiments of the present invention have been described in detail above, it is apparent to those skilled in the art that various modifications and changes can be made to these embodiments. However, it is to be understood that such modifications and changes are within the scope and spirit of the present invention as stated in the claims. Moreover, the present invention described here can have other embodiments, and can be implemented or realized in various ways.

1. A thermo-optical phase shifter comprising a cladding and an optical waveguide core,
wherein the cladding is configured to surround the optical waveguide core; and
the optical waveguide core comprises a first section and a second section, dimensions of the first section and the second section are set to have different dimensions, and the optical waveguide core is distributed in a spiral shape.

2. The thermo-optical phase shifter according to claim 1, wherein the thermo-optical phase shifter further comprises a resistive heater, and wherein the resistive heater is surrounded by the cladding and located on one side of the optical waveguide core, and the resistive heater is separated from the optical waveguide core by the cladding.

3. The thermo-optical phase shifter according to claim 1, wherein the optical waveguide core has resistance performance through ion doping.

4. (canceled)

5. The thermo-optical phase shifter according to claim 1, wherein the optical waveguide core further comprises a bridge structure, one end of the bridge structure is connected with the first section, and the other end of the bridge structure is connected with the second section.

6. The thermo-optical phase shifter according to claim 5, wherein a bending portion of the optical waveguide core and the bridge structure comprise at least one of an arc shape, a line bending shape, an Euler bending shape and a sinusoidal shape.

7. The thermo-optical phase shifter according to claim 5, wherein a dimension of the bridge structure gradually increases from one end to the other end.

8. The thermo-optical phase shifter according to claim 5, wherein the bridge structure comprises a first bridge structure portion and a second bridge structure portion, wherein the first bridge structure portion is a bend waveguide with a uniform dimension, and the second bridge structure portion is a straight waveguide with the dimension gradually changing from one end to the other end.

9. The thermo-optical phase shifter according to claim 1, wherein an air trench or air undercut for thermal insulation is arranged or formed in the cladding, and the air trench or air undercut is located around the optical waveguide core.

10. The thermo-optical phase shifter according to claim 1, wherein the thermo-optical phase shifter further comprises a plurality of third sections and a plurality of bridge structures wherein a number of the third sections is N and a number of the bridge structures is M, dimensions of the N third sections are different, and the dimensions of two spatially adjacent sections of the thermo-optical phase shifter are set to be different.

11. The thermo-optical phase shifter according to claim 2, wherein a material of the resistive heater comprises at least one of titanium nitride, doped silicon, tungsten and gold.

12. The thermo-optical phase shifter according to claim 1, wherein a material of the optical waveguide core comprises at least one of silicon, silicon nitride, silicon dioxide, aluminum oxide, lithium niobate, polymer, germanium and III-V materials.

13. The thermo-optical phase shifter according to claim 1, wherein a waveguide type of the optical waveguide core comprises at least one of a channel waveguide, a ridge waveguide, a slot waveguide and a diffused waveguide.

14. The thermo-optical phase shifter according to claim 1, wherein a wavelength of the optical waveguide core includes, but is not limited to, at least one of a visible light range, a O-band, a C-band and a mid-infrared range.
